(19) United States
(12) Patent Application Publication
(10) Pub. No.: US 2007/0282875 A1
(43) Pub. Date: Dec. 6, 2007

(54) Schema Specified Computable Specification Method and Apparatus

(75) Inventors: Peter KOSS, Northbrook, IL (US); Michael BORELLA, Naperville, IL (US); Ronald MADSEN, Bloomingdale, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTSTARCOM, INC., Alameda, CA (US)

(21) Appl. No.: 11/421,975

(22) Filed: Jun. 2, 2006

(51) Int. Cl. G06F 17/00

(52) U.S. Cl. 707/101

(57) ABSTRACT

Generally speaking, pursuant to these various embodiments, one provides (101) a schema that specifies, at least in part, constraints with respect to structure and content to be imposed with respect to corresponding schema-based documents. This schema is then used (102) to specify a computable specification for a command line interface to be used with a particular corresponding component. By one approach this computable specification comprises at least one facility specification. This facility specification in turn comprises, at least in part, at least one of an operating parameter (or parameters) as pertain to the particular corresponding component and/or a method (or methods) that are capable of being effected via the particular corresponding component. This computable specification is then used (103) to derive at least one of a corresponding command line interface implementation for the particular corresponding component and/or a graphical user interface for a corresponding management application.

### TECHNICAL FIELD

This invention relates generally to command line interface implementations and/or graphical user interfaces.

### BACKGROUND

A command line interface is typically viewed as a user interface to a computer's operating system or an application where the user responds to a visual prompt by typing in a command on a specified line, receives a response back from the system, and then enters another command, and so forth. The MS-DOS Prompt application in a Windows operating system and the UNIX command shell are both examples of the provision of a command line interface. More particularly, a command line interface comprises a terminal-type means for sending commands to the shell and entering data into a computer. The command line is often indicated by a symbol or prompt (such as >, %, or $) that shows a user where to enter such commands. Such an interface typically requires that commands be presented in a precise syntax to ensure correct interpretation by the shell.

Many devices and platforms, including various telecommunications devices, are controlled and/or monitored via a command line interface. Generally speaking, these command line interfaces are custom entities that offer only a limited set of commands that tightly correspond to the abilities, limitations, and/or functionality of the specific platform with which they are employed. When adding something new to such a product, such as a new feature, an engineering team will typically write a specification of the new feature that includes corresponding command line interface requirements. A development team will then use this specification to modify the command line interface and a test team will design test cases to test and confirm the resultant feature implementation. In similar fashion a documentation team will typically then update corresponding user documentation.

Such a process is fraught with problems. A typical command line interface can be very complicated and is often subject to variable interpretation regarding its requirements. This lack of clarity, in turn, often results in inconsistencies between the specification, the implementation, the test cases, and the user documentation (including, but not limited to, online help information). Notwithstanding such issues, however, platform evolution and new feature introduction continues apace. This, in turn, drives the alteration of existing command line interfaces with an increasing risk that such problems as are noted above will be introduced.

Those skilled in the art will appreciate that similar circumstances and problems tend to characterize the specification, implementation, testing, and documentation of graphical user interfaces as well.

### BRIEF DESCRIPTION OF THE DRAWINGS

The above needs are at least partially met through provision of the schema specified computable specification method and apparatus described in the following detailed description, particularly when studied in conjunction with the drawings, wherein:

FIG. 1 comprises a flow diagram as configured in accordance with various embodiments of the invention;

FIG. 2 comprises a schematic view of hierarchical deliverables as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides a schema that specifies, at least in part, constraints with respect to structure and content to be imposed with respect to corresponding schema-based documents. This schema is then used to specify a computable specification for a command line interface to be used with a particular corresponding component. By one approach this computable specification comprises at least one facility specification. This facility specification in turn comprises, at least in part, at least one of an operating parameter (or parameters) as pertain to the particular corresponding component and/or a method (or methods) that are capable of being effected via the particular corresponding component. This computable specification is then used to derive at least one of a corresponding command line interface implementation for the particular corresponding component and/or a graphical user interface for a corresponding management application.

By one approach this schema comprises an extensible markup language (XML) schema. If desired, one may also employ the computable specification to also derive a requirements statement for the corresponding command line interface implementation, test cases for the corresponding command line interface implementation, user documentation for the corresponding command line interface implementation, and so forth.

So configured, the resultant command line interface can comprise a data driven structure. This, in turn, permits the behavior of the command line interface to be readily altered by simply altering the computable specification. This becomes particularly convenient and controlled when the schema itself yields an XML-based command line interface. This results in a command line interface design process that is considerably faster and less prone to error than prior activities in this regard. In particular, many of the existing problems with inconsistencies between the resultant implementation, the user documentation, and the test cases can be dramatically reduced. This in turn results in reduced cycle time, improved accuracy, and an improved user experience as well.

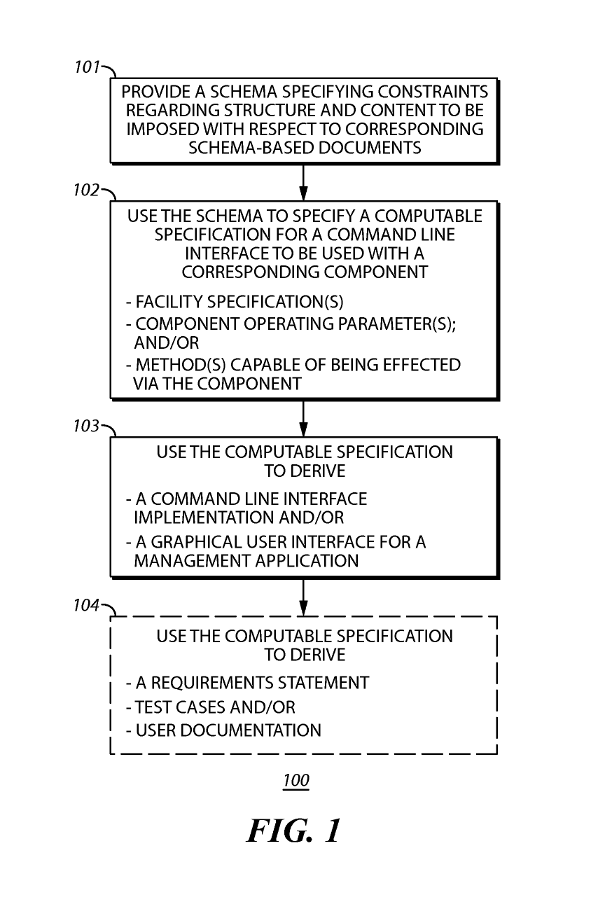

These and other benefits may become clearer upon making a thorough review and study of the following detailed description. Referring now to the drawings, and in particular to FIG. 1, an illustrative corresponding process 100 provides 101 a schema (such as, but not limited to, an extensible markup language (XML) schema) that specifies, at least in part, constraints with respect to structure and content to be imposed with respect to corresponding schema-based documents. In accordance with prior art technique regarding schemas in general, this schema may further provide specificity with respect to the semantics of those schema-based documents as well if desired.

This process 100 then provides for use 102 of that schema to specify a computable specification for a command line interface to be used with a particular corresponding component (comprising physical or logical devices such as, but not limited to, any of a wide variety of telecommunications and networking platforms such as packet data serving nodes (PDSNs) and the like). By one approach this computable specification comprises, at least in part, at least one facility specification (and perhaps more typically a plurality of facility specifications) (where “facilities” are understood in the art to comprise a logical functional entity within a component and are often comprised of corresponding settings (such as items that can be configured by an operator such as timers, thresholds, and Boolean values), statistics (such as items that are typically read-only items that measure certain operators/operations within or performance of the corresponding facility), and alarms (as correspond, for example, to various specified alarm states for certain aspects of a facility).

By one approach this facility specification can further comprise, at least in part, at least one illustrative sequence of command line interface commands that will serve to effect an identified corresponding result. In addition, or in lieu thereof, in some cases it may be helpful if such a facility specification comprises, at least in part, at least one user-discernable information-conveying object such as, but not limited to, a text string, a graphic object, and so forth.

It may also be helpful, at least in some application settings, for the facility specification to further comprise identification of at least one otherwise-available schema-based feature that is to be excluded from a particular facility specification. This can be important when the provided schema offers a relatively rich field of candidate capabilities and opportunities and where it may be important to restrict a particular computable specification from containing an inappropriate reference to or reliance upon a particular capability or opportunity.

Such facility specifications may comprise, at least in part, at least one of an operating parameter(s) and/or a method(s). Such an operating parameter will typically pertain, for example, to the particular corresponding component while the method will typically be one that is capable of being effected via the particular corresponding component.

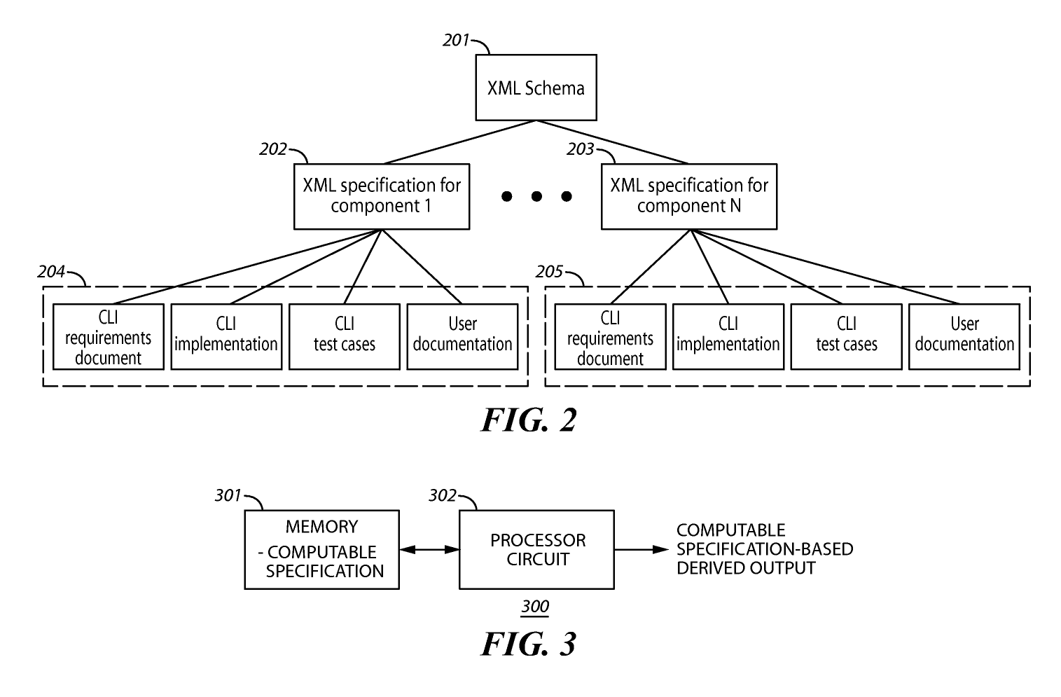

With momentary reference to FIG. 2, these teachings anticipate and encompass the notion that a given schema 201 (shown here for purposes of illustration as an XML schema) can be used as described to specify a plurality of different computable specifications 202 and 203 (show here for purposes of illustration as being XML specifications) to be used with different corresponding components (as suggested here by a reference to a range of components from “component 1” to “component N”). Although these computable specifications 202 and 203 share a common schema starting point, these computable specifications 202 and 203 are likely to differ from one another as a reflection of their intended application with different components.

Referring again to FIG. 1, this process 100 then provides for use 103 of the computable specification to derive at least one of a corresponding command line interface implementation for the particular corresponding component and/or a graphical user interface for a corresponding management application. By one approach this derived command line interface implementation will comprise a data driven command line interface implementation. More particularly, in such a case, deriving the data driven command line interface implementation can comprise specifying command line interface details as a function, at least in part, of the computable specification itself.

In addition, if desired, this process will also optionally provide for using 104 the computable specification to derive additional related elements. For example, one may use the computable specification to derive a requirements statement for the corresponding command line interface implementation for the particular corresponding component. A requirements statement such as this, in turn, can be highly useful when facilitating subsequent changes to the command line interface as this derived requirements statement can serve as a highly accurate and readily available starting point for effecting the anticipated change.

As another example, the computable specification can be used to derive test cases for the corresponding command line interface implementation for the particular corresponding component. More particularly, this can comprise deriving test cases by using the computable specification to automatically derive such things as a test script and/or a test program for the corresponding command line interface implementation.

As yet another example, the computable specification can be used to derive user documentation for the corresponding command line interface. Such user documentation can comprise any of a wide variety of documentation examples including but not limited to online help-based documentation, hypertext markup language (HTML)-based web pages that comprise user documentation, and so forth.

Making momentary reference again to FIG. 2, illustrative examples 204 and 205 of such derived elements for each computable specification 202 and 203 are shown for the purposes of example. Not shown, but also as noted above, this computable specification may also serve to derive a corresponding graphical user interface (either in lieu of the command line interface implementation or as a supplement thereto) if desired.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform 300 will now be provided.

This illustrative platform 300 comprises a memory 301 and a processor circuit 302. The memory 301 has the aforementioned computable specification stored therein. The processor circuit 302, in turn, is operably coupled to the memory 301 and is configured and arranged to use the computable specification as taught herein to thereby provide computable specification-based derived output. For example, this processor circuit 302 can use the stored computable specification to derive a corresponding command line interface implementation for a given corresponding component and/or a graphical user interface as desired. Such a processor circuit 302 may also be configured and arranged to derive the other elements as were described above if desired.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as is known in the art.

A more specific embodiment will now be presented for the sake of illustration. Those skilled in the art will recognize that the details of this example are for illustrative purposes only and are not to be taken as an exhaustive representation of all possible embodiments.

In this example the schema comprises an XML schema. Those skilled in the art will understand that this XML schema is flexible enough to cover multiple logically independent components of, for example, a same device or device family. This schema will be shown to permit an XML designation of a command line interface definition; more particularly, such an XML file can comprise the basis of a formal specification, an implementation, one or more test cases, and user documentation.

Generally speaking, there are two major types of XML files. Facility Specification files specify the facility details per the product's requirements and Command and Dictionary files that provide the System Manager (SM) information about the command structure and other details necessary to execute the various commands (as used herein, “System Manager” will be understood to refer to the main component (such as a host blade or other suitable processing platform) that hosts the command line interface for a given system). The Facility Specifications may comprise a single source for all detailed information regarding the component facilities, their parameters, and custom commands. These may be engineered by, for example, a research and development team and will serve as a source for many different elements including but not limited to automatic generation of the command line interface documentation, simulating the command line interface commands for use in usability studies, and automatically generating System Manager Command and Dictionary XML files.

If desired, the System Manager XML files can be automatically generated from the Facility Specifications using a code generator tool of choice and no direct editing of the Command and Dictionary files is necessary. Those skilled in the art will understand and recognize that corresponding code can also be prepared by hand if desired, though this may result in a loss of efficiency and/or accuracy with respect to the overall process or resultant deliverable.

In this embodiment the XML file essentially comprises a non-ambiguous specification. The following concepts are assumed in this example for the command line interface under discussion:
Component: A physical or logical device in the system. For example, a component might be “system” which refers to a system management blade, or it might be “PDSN” which refers to a PDSN blade.
Facility: A logical functional entity within a component. For a remote access concentrator, a facility might be point-to-point protocol. Each facility may contain groups of:
   Settings: These are items that can be configured by the operator (examples might include timers, thresholds, and Boolean values determining whether or not certain features are enabled in the facility);
   Statistics: These are typically read-only items that measure certain operators within or performance of the facility;
   Alarms: These include, for example, simple network management protocol (SNMP) alarm states for certain aspects of a facility.
Subfacilities: These are logical divisions of function within a certain facility. For example, within a point-to-point protocol facility, there may be subfacilities for link control protocol, authentication, and Internet Protocol control protocol. Subfacilities may also comprise setting, statistics and alarms.
   Individual settings, statistics, and alarms could contain, for example, the following information:
Name
Associated SNMP object
Default value
Range
Format (integer, Boolean, string, and so forth)
Description
Help file text

A facility may contain a set of parameters that are used to provision the facility's operational characteristics or that represent other useful operational information. It is also anticipated that a facility may not have any parameters at all. It is also possible that some facilities may represent information that is tabular in nature. For example an Internet Protocol Address Pool facility may manage more than one Internet Protocol Address Pool. A tabular facility can specify key parameter(s) that uniquely identify a specific item in the facility. For example, an Internet Protocol Address Pool facility can use the name parameter as a key. In this embodiment all commands related to a specific item in a tabular facility will require the key parameter(s) name and value to be entered.

Parameters may be organized into well-known groups such as statistics, settings, or alarms to thereby provide a convenient mechanism for the operator to view, display, or otherwise consider all the parameters within a specific group. In this embodiment, the majority of the command line interface commands are related to showing or setting the parameters of a facility. A facility may also contain a set of unique commands (such as the aforementioned methods) or verbs that are useful only for that specific facility. For example some facilities may have a command to reset their statistical counters.

Although the XML-based Facility Specification is a formal specification regarding facilities and their parameters, keys, and custom methods, this specification need not directly specify the actual syntax of the commands used in the command line interface. In this embodiment, all command line interface commands follow this common syntax:

$$\{ \begin{matrix}\text{set} \\ \text{show} \\ \text{add} \\ \text{delete} \\ \text{help} \\ \text{verb}\end{matrix} \} \begin{matrix}\text{facility} - \text{id} & [ \text{instance} - \text{key} ] [ \{ \begin{matrix}\text{parameter} - \text{id} [ = \text{value} ] … \\ \text{group} - \text{id} \\ \text{option} - \text{keyword}\end{matrix} \} ]\end{matrix}$$

The actual commands are derived by the information in the facility specification.

At the highest level each facility XML specification file in this embodiment identifies one or more facilities each using an id attribute to specify a unique identifier for the specific facility. This is illustrated in Table 1 shown below.

TABLE 1

```
<specifications>
  <facility id=”facility-id” ...>
    [parameters...]
    [methods...]
    [samples...]
    [usage-messages...]
    [exclude...]
  facility description
  </facility>
  <facility id=”facility-id” ...>
    [parameters...]
    [methods...]
    [samples...]
    [usage-messages...]
    [exclude...]
  facility description
  </facility>
</specifications>
```

The opening <facility . . . > tag may contain other attributes as described below. Any general text between the opening and closing <facility . . . > tags is considered the facility description that is used for documentation and manual-page style help commands. Within a facility, parameters, methods, samples, and usage messages may be specified.

The attributes set forth in Table 2 shown below are specified within the opening <facility . . . > tag.

TABLE 2

| Facility Attributes | Usage |
|---|---|
| id=“facility-id” | Required - Unique ID for the facility |
| keyword=“facility- | Required - Must be unique within the parent |
| keyword” | and within the context-type. The keyword is |
| | used to form the valid CLI commands for this |
| | facility. |
| context=“type[;type]” | Required - type can be any of: |
| | system |
| | pdsn |
| | routing-instance |
| [parent=“facility-id”] | Identifies the parent facility if this is a sub- |
| | facility. No parent implies a top-level facility |
| | within a context-type. |
| | Must be a facility-id within the same context- |
| | type. |
| [walk=“parameter-id”] | Used when modeling a facility after a MIB |
| | table. The indicated parameter-id is used in |
| | getnext to list all rows in the table. If not |
| | specified, the first non-key parameter is used. |
| [add=“[method-id]”] | Method executed to add new instances. If the |
| | method-id is not specified, the standard |
| | process for adding new instances will be used. |
| | A <method ...> must be specified with the |
| | same method-id. |
| [add-acl=“levels”] | Security access level(s) required to add new |
| | items. |
| | Levels is semicolon-separated set of admin, |
| | manager, monitor, or calea |
| | Default=”admin;manager” |
| [delete=“[method-id]”] | Method executed to remove/delete existing |
| | instances. If the method-id is not specified, the |
| | standard process for deleting existing |
| | instances will be used. A <method ...> must |
| | be specified with the same method-id. |
| [delete-acl=“levels”] | Security access level(s) required to delete |
| | existing items. |
| | Levels is semicolon-separated set of admin, |
| | manager, monitor, or calea |
| | Default=”admin;manager” |
| [show=“method-id”] | Method executed to show all facility |
| | information. If not specified, the standard |
| | process for showing facility information will |
| | be used. A <method ...> must be specified |
| | with the same method-id. |
| [visible=“yes \| no”] | Indicates if this facility is visible. |
| | Default=”yes”. |
| [cem=“options”] | Options that control CEM behavior. |
| | Specify cem=“no” to completely hide this |
| | facility in the CEM data model. |

The following are used when a non-standard MIB design was used to add
and delete rows in a MIB table. Do not use this if the MIB table uses
the “RowStatus” design pattern.

| | |
|---|---|
| [rowstatus=“parameter- | Used to specify the parameter that is used to |
| id” | control the addition and deletion of rows in a |
| [addstatus=“value”] | MIB table. |
| [deletestatus= | addstatus is the value to set in order to |
| “value”] | ADD a new row. |
| ] | deletestatus is the value to set in order |
| | to DELETE an existing row |

Are-you-sure prompts. Use to confirm the operation.
‘message’ defaults to “Are you sure you want to entire-command
[y/n]?”
Message should be more descriptive as appropriate.
[y/n]? will automatically be append to prompt message

| | |
|---|---|
| [deletePrompt= | Are-you-sure message to display prior to |
| “[message]”] | deleting an instance |
| [addPrompt = | Are-you-sure message to display prior to |
| “[message]”] | adding an instance |
| [showPrompt = | Are-you-sure message to display prior to |
| “[message]”] | showing entire facility properties |

The following, if specified at the facility level, are defaults for all
parameters within the facility that reference a MIB.

| Scope= | PDSN context facility parameters only. | |
|---|---|---|
| “keyword[;keyword...]” | Used to specify the valid scope of PDSN MIB | |
| | objects. Multiple values can be specified | |
| | using semicolon separators. | |
| | Can be any combination of: | |
| | cluster (default) | |
| | blade | |
| | vinstance | |
| combine=”keyword” | PDSN context facility parameters only. | |
| | Used to specify how PDSN MIB objects are | |
| | combined across multiple blades when | |
| | referenced from a cluster. | |
| | The keyword must be one of: | |
| | sum | |
| | uniform (default) | |
| | @function-name | |
| | Although not yet supported, the following | |
| | keywords are reserved for future use: | |
| | max | maximum |
| | min | minimum |
| | prod product | |
| | land logical and | |
| | band bit-wise and | |
| | lor | logical or |
| | bor | bit-wise or |

| | lxor logical xor | |
|---|---|---|
| | bxor bit-wise logical xor | |
| | These are taken from MPI 1.1 (a cluster | |
| | computing spec) section 4.9.2 | |
| distribute=”keyword” | PDSN context facility parameters only. | |
| | Used to specify how PDSN MIB objects are | |
| | distributed across multiple blades when | |
| | referenced from a cluster. | |
| | The keyword must be one of: | |
| | one | instance exists only on |
| | one blade | |
| | all (default) | instance exists on all |
| | blades | |
| | some | instance may exist on |
| | many blades | |

```
  @function-name custom
  determination
```

Parameters in this embodiment, in turn, are specified within the opening and closing <facility> tags as illustrated by the contents of Table 3 shown below.

TABLE 3

```
<facility id=“facility-id” ...>
    <parameter id=”parameter-id” ...>
    parameter description
    </parameter>
  </facility>
```

In this embodiment the attributes set forth in Table 4, presented below, are specified within the opening <parameter . . . > tag:

TABLE 4

| Parameter Attributes | Usage | |
|---|---|---|
| id=“parameter-id” | Required - Unique ID for the parameter | |
| [required=“”] | Required when adding a new instance. | |
| | Always required if within <keys> | |
| [set-acl=“levels”] | Security access level(s) required set the value. | |
| | Levels is semicolon-separated set of admin, | |
| | manager, monitor, or calea | |
| | Default=”admin;manager” | |
| [show-acl=“levels”] | Security access level(s) required to show the | |
| | value. | |
| | Levels is semicolon-separated set of admin, | |
| | manager, monitor, or calea | |
| | Default=”admin;manager;monitor” | |
| [select=“facility-id”] | Setting this parameter requires the <keys> | |
| | from the referenced facility-id | |
| | (eg: set slot=10 cluster | |
| | name=pdsn1) | |
| [get=“method-id”] | Method that executes to retrieve the value. A | |
| | <method ...> must be specified with the same | |
| | method-id. | |
| [set=“method-id”] | Method that executes to set the value. A | |
| | <method ...> must be specified with the same | |
| | method-id. | |
| [compute=“{python-expression}”] | Indicates the value of this parameter is | |
| | computed by the python expression. Curly | |
| | braces are required surrounding the | |
| | expression. | |
| [proxy=“proxy-id”] | Specifies that any SNMP requests for this | |
| | parameter should use the indicated proxy | |
| | address. | |
| | Valid values: | |
| | SC - active Shelf Controller | |
| | PS - active Packet Switch | |
| | SM - active System Manager (normally not | |
| | needed) | |
| | 1:n - specific slot number | |
| [password=“”] | Do not display the actual value of this | |
| | parameter in the CLI | |
| [cem=“options”] | Options that control CEM behavior. | |
| | Specify cem=“no” to completely hide this | |
| | parameter in the CEM data model. | |
| [visible=“yes \| no”] | Indicates if this parameter is visible. | |
| | Default=”yes”. | |
| [hide=“”] | Do not show this parameter in the CLI. Useful | |
| | for MIB tables where there is no need to show | |
| | the actual key/index value. Use hide=“” on the | |
| | key(s) if they should not be displayed. | |
| [summary=“width[alignment]”] | Used to specify that this parameter is included | |
| | in the special summary group. | |
| | Alignment is L, C, or R to indicate the | |
| | alignment (left, center, right). Default is L. | |
| [testvalue=“testValue”] | Used in automated testing. | |
| | Most applicable in key parameters to ispecify | |
| | the value to be used to add/delete entries. | |
| [sample=“sampleValue”] | Used in documentation to provide a samples | |
| | value | |
| [setPrompt=“[message]”] | Are-you-sure message to display prior to | |
| | setting a new value | |
| [mib=“[module:]mib-object- | This parameter is directly associated with a | |
| name[.index-expression]”] | specific MIB object. If used, the properties | |
| | with (*) are inherited from the MIB if not | |
| | directly specified for the parameter. | |
| | Add the optional index-expression to force | |
| | using a specific index. | |
| scope=“keyword[;keyword...]” | PDSN context facility parameters only. | |
| | Used to specify the valid scope of PDSN MIB | |
| | objects. Multiple values can be specified | |
| | using semicolon separators. | |
| | Can be any combination of: | |
| | cluster (default) | |
| | blade | |
| | vinstance | |
| combine=”keyword” | PDSN context facility parameters only. | |
| | Used to specify how PDSN MIB objects are | |
| | combined across multiple blades when | |
| | referenced from a cluster. | |
| | The keyword must be one of: | |
| | sum | |
| | uniform (default) | |
| | @function-name | |
| | Although not yet supported, the following | |
| | keywords are reserved for future use: | |
| | max | maximum |
| | min | minimum |
| | prod product | |
| | land logical and | |
| | band bit-wise and | |
| | lor | logical or |
| | bor | bit-wise or |

| | lxor logical xor | |
|---|---|---|
| | bxor bit-wise logical xor | |
| | These are taken from MPI 1.1 (a cluster | |
| | computing spec) section 4.9.2 | |
| Distribute=”keyword” | PDSN context facility parameters only. | |
| | Used to specify how PDSN MIB objects are | |
| | distributed across multiple blades when | |
| | referenced from a cluster. | |
| | The keyword must be one of: | |
| | one | instance exists only on |
| | one blade | |
| | all (default) | instance exists on all |
| | blades | |
| | some | instance may exist on |
| | many blades | |

| | |
|---|---|
| | @function-name custom |
| | determination |
| [set-cli- | Valid keyword/value pairs separated by |
| enum=“key(value)[;...]”] | semicolons used for a set operation. If not |
| | specified, the enum attribute will be used if |
| | specified. |
| [cidr-address=”parameter- | Used only in conjunction with syntax=‘cidr’ |
| id”] | Specifies the parameter associated with the |
| | address part of cidr parameter. |
| [cidr-netmask=”parameter- | Used only in conjunction with syntax=‘cidr’ |
| id”] | Specifies the parameter associated with the |
| | netmask part of cidr parameter. |

The following attributes will be inherited from the referenced MIB object definition if
referencing a MIB - but can be overridden if explicitly specified. They are also VALID
for any non-MIB parameter.

| | |
|---|---|
| [syntax=“syntax-keyword”] | *ipaddress \| integer \| string \| |
| | boolean \| cidr |
| [access=“access-keyword”] | *rw \| ro \| rc \| na |
| | na: not-accessible usually from an SNMP |
| | table index |
| [default=“default-value”] | *Default value if applicable |
| [units=“unitsString”] | *The UNITS of measure for this parameter |
| | See also set-cli-enum above. |
| [enum=“key(value)[;...]”] | *Valid keyword/value pairs separated by |
| | semicolons |
| [range=“low[..high]”] | *Valid ranges for numeric values. Single digit |
| | or low..high |
| [hint=“hintSpecification”] | *ASN.1 style display-hint |
| | SPECIAL HINT VALUES |
| | The AGW uses three different time epochs. If |
| | referencing a MIB that is defining a |
| | timestamp, please use one of: |
| | hint=“@Time1900” |
| | hint=“@Time1970” |
| | hint=“@Time1996” |

NOTE: The following are automatically added if referencing a MIB but can be
overridden by specifying in the <parameter ...>

| | |
|---|---|
| [mibsyntax=“syntax”] | *The ASN.1 syntax as specified in the MIB. |
| | This could be a Textual-Convention |
| [basesyntax=“syntax”] | *The base ASN.1 syntax possibly via a |
| | Textual-Convention |
| [oid=“dotted-oid”] | *The dotted OID associated with accessing the |
| | associated MIB object. |
| | This will include the option dotted-index if |
| | specified in the mib=“...” |
| [index=“implied \| | *If this parameter is an index, indicates if it is |
| standard”] | IMPLIED or not. |
| [reference=“phrase”] | *The value of the REFERENCE clause for the |
| | MIB object. |
| | Example usage for FFD reference: |
| | reference=“[1342]” square brackets |
| | required |

If desired, parameters may be grouped by enclosing the appropriate <parameter . . . > specifications within <group> tags as suggested by the contents of Table 5 presented below:

TABLE 5

```
<facility id=“facility-id” ...>
    <group id=”group-id” ...>
    <parameter id=”parameter-id” ...>
    </parameter>
    <parameter id=”parameter-id” ...>
    </parameter>
    </group>
  </facility>
```

By one approach, individual parameters are precluded from inclusion in multiple groups.

With some facilities having multiple entries it may be desirable to show multiple entries in a tabular fashion. If desired, all parameters that specify the summary=“width[alignment]” attribute could be automatically included in a special parameter group with a group-id of ‘summary’. The command line interface process could then display this special group in a tabular manner. An illustrative example appears in Table 6 presented below:

TABLE 6
prompt# show slot summary
[slot summary]

| num | type | state | version | bios | uptime |
|---|---|---|---|---|---|
| 1 | sc | idle | 04.00.002 | 01.02.06 | 0 days, 0:57:25.0 |
| 2 | sc | active | 04.00.002 | 01.02.06 | 14 days, 21:47:24.0 |
| 4 | ps | active | 4.0.4 | 4.0.57 | 14 days, 21:46:32.45 |
| 5 | sm | active | 04.00.007 | 14.0.0 | 10 days, 4:21:11.79 |
| 6 | sm | idle | 04.00.007 | 14.0.0 | 10 days, 4:20:9.47 |
| 10 | pdsn | active | 4.0.4 | 2.0.22 | 10 days, 4:19:25.48 |

When a facility is tabular in nature it may also be possible and/or useful to enclose parameters within <keys> tags that identifies the key parameters. An illustrative example appears below in Table 7.

TABLE 7

```
<facility id=“facility-id” ...>
    <keys>
    <parameter id=”parameter-id” ...>
    </parameter>
    <parameter id=”parameter-id” ...>
    </parameter>
    </keys>
  </facility>
```

Methods as described above may be specified within the opening and closing <facility> tags as per Table 8 shown below.

TABLE 8

```
<facility id=“facility-id” ...>
    <method id=”method-id” ...>
    method description
    </method>
  </facility>
```

To exemplify in detail, Table 9 sets forth illustrative attributes that may be specified in this embodiment within the opening <method . . . > tag.

TABLE 9

| Method Attributes | Usage |
|---|---|
| id=“method-id” | Required - Unique ID for the method |
| | The actual implementation will be a script |
| | whose name is the same as the method-id. |
| | method-id.py Python |
| | method-id.xxx Other script |
| [execute-acl=“levels”] | Security access level(s) required to execute |
| | the method/verb. |
| | Levels is semicolon-separated set of admin, |
| | manager, monitor, or calea |
| | Default=”admin;manager” |
| [background=“y”] | Forces the method to run in the background |
| | Note: background=‘n’ is not supported |
| [scope=“facility \| | If scope=facility, instance keys are NOT |
| instance”] | required |
| | Default = instance if keys are specified |
| [verb=“verb-keyword”] | Unique keyword/verb used to invoke this |
| | method |
| | If NOT specified, this method cannot be |
| | directly invoked by the operator. |
| [option=“option-keyword”] | Option keyword |
| | (eg: reboot slot=5 noswitchover) |
| [parameter=“parameter-id[;...]”] | Required parameter(s) when executing this |
| | command. |
| | If the parameter(s) is only used in this |
| | command, tag the parameter with hide=“” |
| | (eg: add bios filename=xxx) |
| [executePrompt=“[message]”] | Are-you-sure message to display prior to |
| | executing this method/verb |
| [command=“specific | A specific shell command associated with this |
| command”] | method |
| | (eg: command=“telnet |
| | 127.0.0.1:111”) |
| [builtin=“y”] | Indicates that this method/verb is a built-in |
| | command implemented within the CLI |
| | process itself. |
| [cem=“options”] | Options that control CEM behavior. |
| | Specify cem=“no” to completely hide this |
| | method in the CEM data model. |
| [visible=“yes \| no”] | Indicates if this method is visible. |
| | Default=”yes”. |
| [controlparameter=’parameter | Used by some method implementations to specify |
| -id’] | which parameter controls the operation. Currently |
| | used by reset verbs. |
| [controlvalue=’value’] | Used by some method implementations to specify the |
| | value the control parameter uses in the operation. |
| | Currently used by reset verbs. |
| | Note: When specifying for use by the reset verb, if |
| | the controlparameter is of type DateAndTime, the |
| | controlvalue should not be specified. |

As noted above, it may be desirable to specifically exclude certain otherwise available content when practicing these teachings. Excluded entries can be used to formally acknowledge objects that are to be excluded from a resultant command line interface (though the exclusion entry will preferably have no affect on the command line interface itself). That is, these entries can primarily serve to track the decisions being made with respect to such object exclusion. In this illustrative embodiment certain Mobile Internet Protocol objects are to be excluded and are specified within the opening and closing <facility> tags as suggested by the content of Table 10 shown below.

TABLE 10

```
<facility id=“facility-id” ...>
    <exclude id=“mib-Object-Name”>
    reason for excluding the object
    </exclude >
  </facility>
```

It may also be helpful to the reader's understanding to also describe the design of System Manager command and dictionary XML files. In this illustrative embodiment there is a single XML formatted file for each context (such as, for example, system.xml, pdsn.xml, and routing-instance.xml). These files can be automatically generated using an automated code generation tool of choice and/or by hand as may be appropriate in a given application setting. Table 11, shown below, demonstrates that, at a highest level, the content XML file identifies the context and contains two major segments as well (in this case, command and dictionary).

TABLE 11

```
<context>
    <command>
        [command-tree]
    </command>
    <dictionary>
        [dictionary-tree]
    </dictionary>
</context>
```

In this embodiment the command section defines all the valid commands for the context in tree form. The dictionary section, in turn, contains detailed information about each facility along with its parameters and methods. The command tree section can define all valid command line interface commands by modeling the segments of the valid commands in tree form. This would allow, of course, efficient command parsing and command completion capabilities.

Table 12 shown below represents such a construct, where the first level (i.e., <command> in the depicted example) operates as a verb and where each XML tag represents the keyword that is required to be entered to invoke that specific command. (The specific example provided in Table 12 illustrates two commands: activating a system alarm cutoff and adding a bios filename.)

TABLE 12

```
  <command>
      <activate>
        <system ...>
            <alarm-cutoff ...>
            </alarm-cutoff>
        </system>
    </activate>
    <add>
        <bios ...>
            <filename ...>
            </filename>
        </bios>
    <add>
    .
    .
    .
</command>
```

As already noted above, the dictionary section contains detailed information about each facility along with its parameters and methods. To illustrate, Table 13 presents an example where all tags immediately below <dictionary> represent each facility in the context.

TABLE 13

```
  <dictionary>
    <facility:bios ...>
        [parameters...]
        [methods...]
        [usage...]
    facility description
    </facility:bios>
    <facility:system ...>
        [parameters...]
        [methods...]
        [usage...]
    facility description
    </facility:system>
    .
    .
    .
</dictionary>
```

As noted earlier, each facility may have one or more parameter and/or method specifications. Table 14 presents an illustrative example in this regard (the parameters will be in the order as found in the original source facility XML specification and the tag for each parameter is formed using “parameter:parameter-id” while the tag for each method is formed using “method:method-id.”)

TABLE 14

```
<facility:bios ...>
    <parameter:id ...>
    parameter description
    </parameter:id>
    <parameter:type ...>
    parameter description
    </parameter:type>
    <parameter:version ...>
    </parameter:version>
    <method:add-bios ...>
    method description
    </method:add-bios>
  </facility:bios>
```

Although the XML facility specification is a formal specification regarding facilities, their parameters, keys, and custom methods, they do not directly specify the actual syntax of the command line interface commands. Instead, this XML content is interpreted to facilitate derivation of those actual commands. The general design of all command line interface commands may be as follows:

$$\{ \begin{matrix}\text{set} \\ \text{show} \\ \text{add} \\ \text{delete} \\ \text{help} \\ \text{verb}\end{matrix} \} \begin{matrix}\text{facility} - \text{id} & [ \text{instance} - \text{key} ] [ \{ \begin{matrix}\text{parameter} - \text{id} [ = \text{value} ] … \\ \text{group} - \text{id} \\ \text{option} - \text{keyword}\end{matrix} \} ]\end{matrix}$$

where the meanings of these expressions are set forth in Table 15 below:

TABLE 15

| | |
|---|---|
| verb | A custom verb keyword used to invoke some specific action on the |
| | facility. For example reset. |
| | Creating new verbs should be done cautiously to ensure we use the |
| | same verb when implying a similar operation. |
| facility-id | A unique identifier that determines the facility that the command |
| | operates on. For example ppp |
| | If the command is for a sub-facility, the identifier will be a space-separated |
| | set of keywords. For example: ppp auth |
| instance-key | When a facility has multiple instances (eg: a list of items) the |
| | instance-key is used to identify the specific item that the command |
| | operates on. For example the RADIUS server facility has multiple |
| | items, or multiple servers, each identified by some key. For |
| | example the RADIUS server whose |
| | address=149.112.80.25. |
| | Instance keys are formed by key-id=value pairs. If this requires |
| | multiple keys to uniquely identify the specific item, then more than |
| | one key-id=value pair must be used. |
| | Other than show and help, most commands associated with a |
| | facility with multiple items require the use of the instance-key. |
| parameter-id | Used to reference a specific parameter associated in the facility. |
| value | Typically only used when setting the parameter's value |
| group-id | Facilities may group their parameters into convenient sets, such as |
| | settings or statistics. Using a group-id in a command |
| | implies that the verb applies to all parameters in that group. |
| | Creating new group-ids should be done cautiously to ensure we |
| | use the same term when grouping parameters with similar |
| | characteristics. |
| option-keyword | Some commands may accept various option keywords that control |
| | the specific commands behavior. This is only used for non- |
| | standard, or custom, verbs. |
| | Creating new option-keywords should be done cautiously to |
| | ensure we use the same term when implying a similar option. |

In many cases it may be preferable to use “grouping” at a facility level to identify the settings and/or statistics rather than specifying a settings or statistics sub-facility. This allows, for example, a higher-level facility “show facility-id statistics” command to show the statistics for the facility and all sub-facilities.

In any event, Table 16 presents various rules that may be employed to determine the commands to be associated with a given facility.

TABLE 16

| Command | Rule |
|---|---|
| show facility-id | If a facility, or any of it's sub- |
| show ppp auth | facilities, have any non-hidden |
| | parameters. |
| | NOTE: Even if a facility has no |
| | parameters, it may have a show |
| | facility-id command. |
| | This command will show all |
| | parameters and their values for this |
| | facility and all sub-facilities |
| | (recursively). |
| | If the facility has multiple items, then |
| | this command will show all |
| | parameters and their values for each |
| | item. |
| show facility-id group-id | If this facility, or any of it's sub- |
| show ppp auth statistics | facilities, has any parameters that |
| show ppp statistics | have been grouped. |
| | NOTE: If this is a sub-facility, each |
| | parent facility must have a similar |
| | command to show facility-id group-id |
| | This command will show all |
| | parameters in the specified group for |
| | this facility and all sub-facilities |
| | (recursively). |
| help facility-id | Automatically included as a valid |
| help ppp auth | command |
| show facility-id instance-key | If a facility has any keys specified. |
| show ip network name=RP | This command will show all |
| | parameters and their values for the |
| | item identified using the instance- |
| | key. |
| show facility-id [instance-key] | For each parameter that is not hidden |
| parameter-id | and not a key. |
| show ip network name=RP address | This command will show a specific |
| | parameter and its value for the item |
| | identified using the instance-key. |
| set facility-id [instance-key] | For each parameter that is not hidden, |
| parameter-id=value | not a key and access is read-write |
| set ip network | |
| name=RP enable=off | |
| add facility-id [instance-key] | If a facility has any keys specified |
| [parameter-id=value]... | and new items can be added. The |
| add ip network name=PI | instance-keys specify the key values |
| address=149.112.237.33/24 | for the new item. Any additional |
| enable=on | parameter-id=value are used to set |
| | the initial values for other parameters |
| | for the new item. |
| delete facility-id [instance-key] | If a facility has any keys specified |
| delete ip network name=PI | and existing items can be deleted. |
| | The instance-keys specify the key |
| | values for the item being deleted. |
| verb facility-id [instance-key] | For each custom method that |
| [option-keyword] [parameter- | specifies a verb. |
| id=value] | instance-key required only if the |
| busyout slot number=8 | custom method is associated with an |
| | instance, otherwise instance-key is |
| | not required. |
| | option-keyword only if specified. |
| | parameter-id=value only if specified. |

Those skilled in the art will recognize that the specifics provided above are illustrative in nature and that a given designer may well chose different implementation details to suit the needs and/or limitations of a given application setting. Consequently, the specific values, definitions, field names, abbreviations, and so forth presented above are to be viewed as a non-exhaustive listing and without any intent to otherwise limit the ambit of these teachings.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a schema that specifies, at least in part, constraints with respect to structure and content to be imposed with respect to corresponding schema-based documents;
using the schema to specify a computable specification for a command line interface to be used with a particular corresponding component wherein the computable specification comprises at least one facility specification and wherein the at least one facility specification comprises, at least in part, at least one of:
at least one operating parameter as pertains to the particular corresponding component; and
at least one method capable of being effected via the particular corresponding component;
using the computable specification to derive at least one of:
a corresponding command line interface implementation for the particular corresponding component;
a graphical user interface for a corresponding management application.

2. The method of claim 1 wherein the schema comprises an extensible markup language (XML) schema.

3. The method of claim 1 wherein deriving a corresponding command line interface implementation comprises deriving a data driven command line interface implementation.

4. The method of claim 3 wherein deriving a data driven command line interface implementation comprises specifying command line interface details as a function, at least in part, of the computable specification.

5. The method of claim 1 wherein the computable specification comprises a plurality of facility specifications.

6. The method of claim 1 wherein the at least one facility specification further comprises, at least in part, at least one illustrative sequence of command line interface commands that will serve to effect an identified corresponding result.

7. The method of claim 1 wherein the at least one facility specification further comprises, at least in part, at least one user-discernable information-conveying object.

8. The method of claim 7 wherein the user-discernable information-conveying object comprises a text string.

9. The method of claim 1 wherein the at least one facility specification further comprises, at least in part:
at least one illustrative sequence of command line interface commands that will serve to effect an identified corresponding result;
at least one user-discernable information-conveying object.

10. The method of claim 1 wherein the at least one facility specification further comprises, at least in part, identification of at least one otherwise-available schema-based feature that is to be excluded from a particular facility specification.

11. The method of claim 1 further comprising:
using the computable specification to derive a requirements statement for the corresponding command line interface implementation for the particular corresponding component.

12. The method of claim 1 further comprising:
using the computable specification to derive test cases for the corresponding command line interface implementation for the particular corresponding component.

13. The method of claim 12 wherein using the computable specification to derive test cases for the corresponding command line interface implementation for the particular corresponding component further comprises using the computable specification to automatically derive at least one of a test script and a test program for the corresponding command line interface implementation for the particular corresponding component.

14. The method of claim 1 further comprising:
using the computable specification to automatically derive user documentation for the corresponding command line interface implementation for the particular corresponding component.

15. The method of claim 14 wherein the user documentation comprises on-line HELP-based documentation.

16. The method of claim 14 wherein the user documentation comprises at least one Hypertext Markup Language-based web page comprising user documentation.

17. An apparatus comprising:
a memory having stored therein a computable specification for a command line interface to be used with a particular corresponding component, wherein the computable specification is specified at least in part by a schema that specifies, at least in part, constraints to be imposed with respect to corresponding schema-based document structure and content, and wherein the computable specification comprises at least one facility specification and wherein the at least one facility specification comprises, at least in part:
at least one operating parameter as pertains to the particular corresponding component; and
at least one method capable of being effected via the particular corresponding component;
a processor circuit operably coupled to the memory and being configured and arranged to use the computable specification to derive a corresponding command line interface implementation for the particular corresponding component.

18. The apparatus of claim 17 wherein the schema comprises an extensible markup language (XML) schema.

19. The apparatus of claim 17 wherein the computable specification comprises a plurality of facility specifications.

20. The apparatus of claim 17 wherein the at least one facility specification further comprises, at least in part, at least one illustrative sequence of command line interface commands that will serve to effect an identified corresponding result.

21. The apparatus of claim 17 wherein the at least one facility specification further comprises, at least in part, at least one user-discernable information-conveying object.

22. The apparatus of 21 wherein the user-discernable information-conveying object comprises a text string.

23. The apparatus of claim 17 wherein the at least one facility specification further comprises, at least in part, identification of at least one otherwise-available schema-based feature that is to be excluded from a particular facility specification.

24. The apparatus of claim 17 wherein the processor circuit is further configured and arranged to use the computable specification to derive a requirements statement for the corresponding command line interface implementation for the particular corresponding component.

25. The apparatus of claim 17 wherein the processor circuit is further configured and arranged to use the computable specification to automatically derive at least one of a test script and a test program for the corresponding command line interface implementation for the particular corresponding component.

26. The apparatus of claim 17 wherein the processor circuit is further configured and arranged to use the computable specification to automatically derive user documentation for the corresponding command line interface implementation for the particular corresponding component.
